(19) United States
(12) Patent Application Publication
(10) Pub. No.: US 2009/0076970 A1
(43) Pub. Date: Mar. 19, 2009

(54) System and method for sending actionable offer alerts in electronic messages

(75) Inventor: Aleem R. Mawani, Markham (CA)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/208,242

(22) Filed: Sep. 10, 2008

Related U.S. Application Data
(60) Provisional application No. 60/973,125, filed on Sep. 17, 2007.

(51) Int. Cl. G06Q 30/00; G06Q 50/00

(52) U.S. Cl. 705/80

(57) ABSTRACT

Methods, systems and apparatus for communicating an advertisement offer. In one aspect, a computer-implemented method includes receiving an offer to place an advertisement in a publication; generating an electronic message including one or more items of information corresponding to the offer; including in the electronic message an actionable link associated with the offer, wherein the actionable link can be selected to respond to the offer; and transmitting the electronic message to an offer recipient.

This application claims priority to U.S. Provisional Patent Application Ser. No. 60/973,125 filed on Sep. 17, 2007, entitled “System and Method for Sending Actionable Offer Alerts in Electronic Messages.” The disclosure of the prior application is considered part of, and is incorporated by reference in, the disclosure of this application.

### TECHNICAL FIELD

The following disclosure relates to generating and transmitting electronic advertisement offers that include one or more actionable links, and to systems and methods for presenting information and processing input in response to activation of an actionable link included in an electronic message.

### BACKGROUND

Advertisers can submit advertising copy (or “ad copy”) to a publisher for inclusion in a printed publication, such as a newspaper or a magazine. Typically, the ad copy can be provided in the form of a proof, which presents the advertisement using the format in which the advertisement should be run. The proof can be in hard copy form or electronic form. The publisher can then manually process the proof to incorporate it into the printed publication.

An advertiser typically also specifies the placement of the ad copy in the printed publication, including parameters such as the edition in which the ad copy is to appear, the page on which the ad copy is to run, and the size of the advertisement. If the ad copy supplied by the advertiser fails to satisfy one or more threshold criteria, the ad copy may not be included in the desired printed publication. Further, manual processing of the ad copy can delay notification to the advertiser that a piece of ad copy fails to satisfy one or more criteria.

An advertiser also must determine what advertising space is available for a particular edition of a printed publication. Typically, an advertiser can interact with the publisher to determine the format of the printed publication and the advertisement sizes available. For example, the size of an advertisement can be expressed using a number of parameters, including the height and width, or number of columns. The available advertising space can change between editions and also between sections of a single edition.

Once made, an offer to purchase advertising space in a printed publication is evaluated by the publisher to determine whether the ad copy will be accepted. Typically, advertisers negotiate terms with the publisher, such as through a sales representative. For example, a publisher can provide standard rates and terms for a particular publication to a sales representative. If an advertiser accepts those terms, the ad copy can be placed in the printed publication. Further, a publisher can offer special terms or preferential pricing, such as for volume customers and new advertisers. Generally, the applicable rates and terms are provided to advertisers upon request.

### SUMMARY

An actionable offer alert system and method for sending electronic messages can be implemented to notify an offer recipient, e.g., a print media publisher, of the opportunity to accept, reject, or propose a counteroffer in response to an advertisement offer. The actionable offer alert system can be implemented as an online, e.g., web-based, electronic messaging system that presents an offer recipient with an electronic message embedded with one or more actionable links for accepting, rejecting, or countering the advertisement offer.

The present inventors recognized the need to develop an actionable offer alert system for providing an electronic message to an offer recipient in response to an outstanding, or pending, advertisement offer. The actionable offer alert system can be implemented to notify a publisher of an advertisement offer submitted for inclusion in a publication by generating an electronic message that includes an actionable link associated with the offer. The electronic message can include one or more items of information corresponding to the advertisement offer. Further, the present inventors recognized the need to permit a publisher to access an advertisement offer by selecting the actionable link included in the electronic message. Additionally, the present inventors recognized the need to permit a publisher to specify an action in response to the advertising offer through the electronic message.

In one aspect, a computer-implemented method of communicating an advertisement offer includes receiving an offer to place an advertisement in a publication. An electronic message including one or more items of information corresponding to the offer is generated. The electronic message includes an actionable link associated with the offer. The actionable link can be selected to respond to the offer. The electronic message is transmitted to an offer recipient.

This and other aspects can include one or more of the following features. An offer page including one or more fields corresponding to the offer in response to a selection of the actionable link can be displayed. Including in the electronic message an actionable link can further include in the electronic message a plurality of actionable links associated with the offer. A selection of one of the plurality of actionable links can be detected. Responding to the offer can be based on the detected selection. In response to a selection of one of the plurality of actionable links, at least one field included in the offer page can be pre-populated in accordance with the actionable link selected. The plurality of actionable links can include one or more of an accept link, a reject link, a counteroffer link, and a view offer link. The one or more items of information corresponding to the offer can include at least one of: a publication identifier, an advertiser identifier, an offer value, an issue date, and an advertisement description. The actionable link associated with the offer can include a hyperlink.

The techniques described in this specification can be implemented to realize one or more of the following potential advantages. For example, the techniques can be implemented to increase publisher responsiveness to outstanding advertisement offers by permitting immediate access to a particular offer.

Moreover, the techniques can be implemented to include a narrative in an electronic message advising, or otherwise encouraging, an offer recipient to respond to an offer by taking one or more actions. The techniques also can be implemented to include accepting, rejecting or countering an advertisement offer by a publisher through the selection of an actionable link in an electronic message. Further, selection of an actionable link can cause a corresponding offer page to be displayed in a web browser window. For example, an actionable link can be a hyperlink to a corresponding offer page in which an advertisement offer can be presented in increased detail before a response to the advertisement offer is submitted. In addition, the techniques can be implemented to expedite publisher responsiveness by preselecting an action in the corresponding offer page. Furthermore, the techniques can be implemented to prevent outstanding offers from becoming stagnant in the actionable offer alert system by alerting a publisher to take action on pending advertisement offers.

Details of one or more implementations are set forth in the accompanying drawings and the description below. Other aspects can be implemented in systems and computer program products, encoded on a computer-readable medium, operable to cause data processing apparatus to perform such operations. Other features, aspects, and advantages will become apparent from the description, the drawings, and the claims.

### BRIEF DESCRIPTION OF THE DRAWINGS

FIG. 1 shows an exemplary electronic message that can be transmitted to an offer recipient.

FIG. 2 shows an exemplary electronic message providing an offer summary that can be transmitted to an offer recipient.

FIG. 3 shows an exemplary electronic message including one or more actionable links associated with an offer.

FIG. 4 shows an exemplary offer page displayed in a web browser window.

FIG. 5 is a flow diagram describing an exemplary data input process for communicating an advertisement offer.

FIG. 6 is a schematic diagram of a computing device and system that can be used to implement the transmission of actionable offer alerts in electronic messages.

Like reference symbols indicate like elements throughout the specification and drawings.

### DETAILED DESCRIPTION

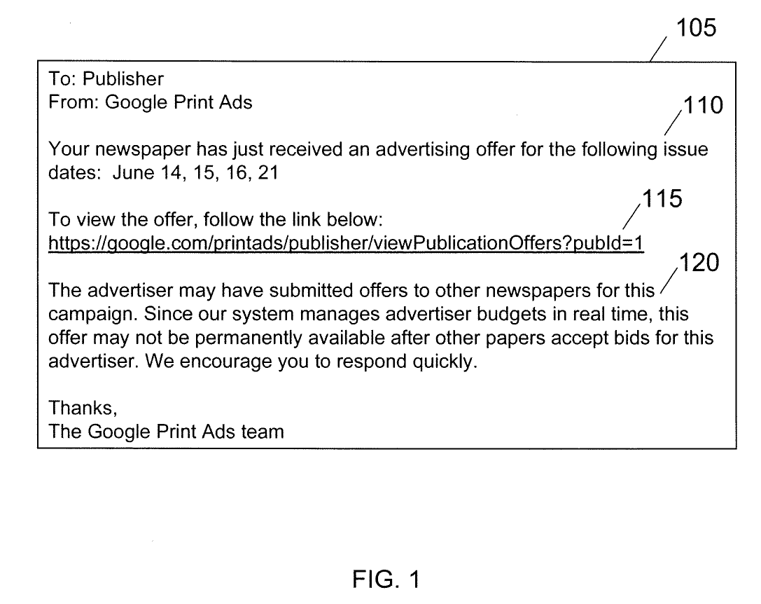

FIG. 1 shows an exemplary electronic message 105 that can be transmitted to an offer recipient. The electronic message 105 can be provided by an actionable offer alert system, which can include an actionable offer alert software application installed, e.g., on a computer system. The electronic message 105, e.g., an electronic mail message (or email), can be generated in response to an offer to purchase an item, such as advertising space in a publication. For example, an offer to purchase advertising space in a publication can be submitted to an offer recipient, such as a publisher of an electronic publication or a print media publication. The offer recipient can receive the offer to purchase in the electronic message 105, which notifies the publisher that an advertiser has submitted an offer to purchase and supplies information associated with the offer. The offer recipient can receive the offer to purchase advertisement space directly from the advertiser. Alternatively, an offer to purchase advertising space in a publication can be submitted to a broker or reseller. The advertiser can be any party who submits an offer to advertise in a publication.

The electronic message 105 can include one or more items of information corresponding to the offer to place the advertisement in the publication, including the date for which the offer is valid and the identity of the advertiser (110). The electronic message 105 also can include an actionable link 115, such as a hyperlink, that can be selected to access additional information. Selecting the actionable link 115 can cause a corresponding offer page to be displayed, such as in a web browser window generated by the computer system. The corresponding offer page can include additional items of information corresponding to the advertisement offer. Additionally, the electronic message 105 can include a narrative 120 advising, encouraging, or otherwise directing an offer recipient to perform an action in response to an offer. For example, the narrative 120 can indicate that the associated offer is conditional, subject to expiration, or that it can be withdrawn without notice.

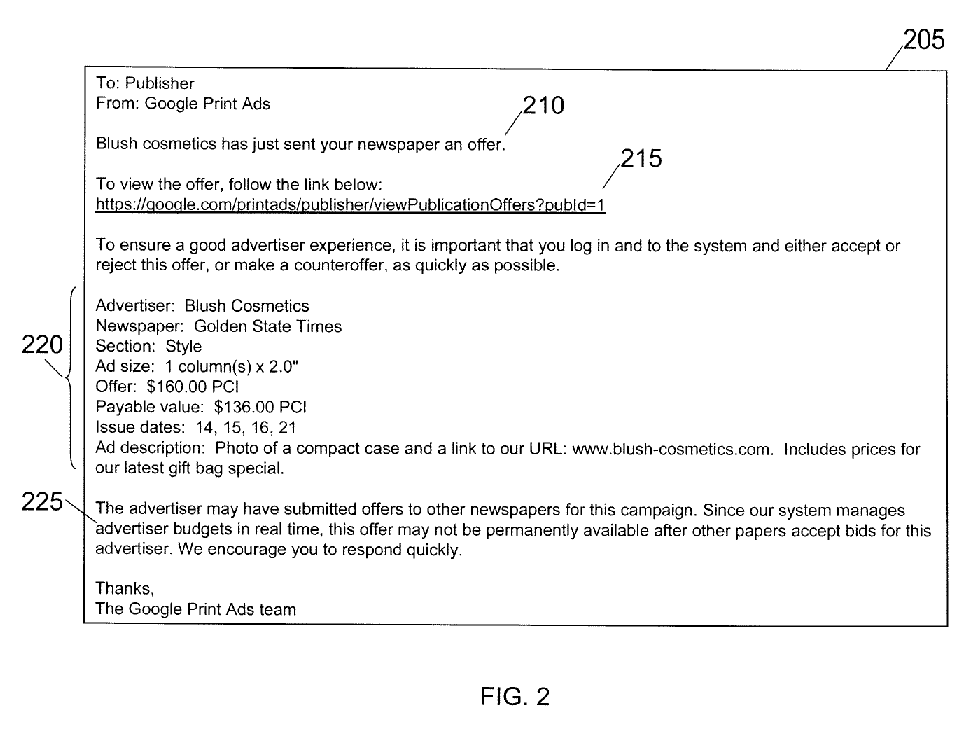

FIG. 2 shows an exemplary electronic message 205 providing an offer summary that can be transmitted to an offer recipient. Similar to the electronic message 105, the electronic message 205 can be generated in response to an offer to purchase advertising space in a publication. The electronic message 205 can identify the advertiser 210 from whom the offer was received. The electronic message 205 also can include an actionable link 215, such as a hyperlink, that can be selected to view one or more items of information corresponding to the offer. Selecting the actionable link 215 also can cause a corresponding offer page to be displayed, such as in a web browser window generated by the computer system. The corresponding offer page can include additional items of information corresponding to the advertisement offer.

An offer summary 220 can be included in the electronic message 205. The offer summary 220 can describe one or more details regarding the offer, such that the offer can be evaluated by the publisher before selecting the actionable link 215. For example, the offer summary 220 can include information identifying any or all of: the advertiser, the publication and section in which the advertisement is to appear, the size of the advertisement, an offer amount, a payable value, the date of one or more issues in which the advertisement is to be included, and a description of the advertisement. In other implementations, the offer summary 220 can include other information, including information relating to the advertiser. Additionally, the electronic message 205 can include a narrative 225 advising, encouraging, or otherwise directing an offer recipient to perform an action in response to an offer. For example, the narrative 225 also can indicate that the associated offer is conditional, subject to expiration, or that it can be withdrawn without notice.

The actionable links 115 and 215 of electronic messages 105 and 205, respectively, can be selected, e.g., clicked on, to access additional information relating to the advertisement offer. Upon selection of an actionable link 115 or 215, an offer page can be presented, such as in a web browser. The offer page further can include one or more actionable links, including links for accepting, rejecting, or countering the corresponding advertisement offer. By selecting an actionable link in the offer page, the offer recipient can submit an action in response to the advertisement offer and can prevent the offer from becoming moot or stagnant in the actionable offer alert system. For example, an offer can become moot if it has not been accepted before a proposed issue date or if the offer is withdrawn.

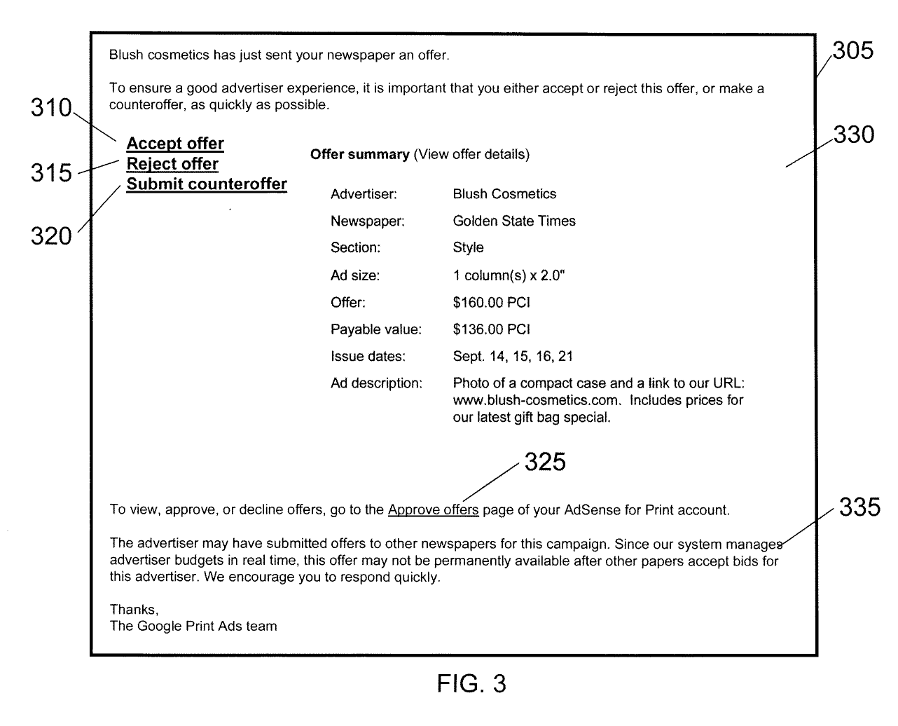

FIG. 3 shows an exemplary electronic message 305 including one or more actionable links associated with the offer. The one or more actionable links included in the electronic message 305 can be used by the publisher to indicate an action corresponding to the offer. For example, the one or more actionable links can include an accept offer link 310, a reject offer link 315, and a submit counteroffer link 320. The electronic message 305 also can include an approve offers link 325, which can cause an account summary page associated with the publisher to be displayed. For example, the approve offers link 325 can be selected to present an offer page that includes one or more outstanding offers pending for an offer recipient.

Similar to the electronic message 205 shown in FIG. 2, the electronic message 305 can include an offer summary 330 that includes one or more items of information corresponding to the advertisement offer identified in the electronic message 305. In some implementations, a publisher can evaluate the offer based on the offer summary 330 and can determine whether the offer should be accepted, rejected, or countered. Further, one of the one or more actionable links included in the electronic message 305 can be selected to respond to the offer. For example, the accept offer link 310 can be selected if the offer is acceptable. Conversely, the reject offer link 315 can be selected if the offer is unacceptable. Additionally, the submit counteroffer link 320 can be selected if the publisher would like to alter one or more of the proposed terms.

Selecting the accept offer link 310, the reject offer link 315, the submit counteroffer link 320, or the approve offers link 325 can cause an offer page to be displayed in a web browser window. The offer page can include one or more of the pending advertisement offers submitted to the publisher for inclusion in a publication. The pending offers can be displayed, e.g., in a list, in the offer page. If more than one advertisement offer is listed in the offer page, the offer associated with the electronic message 305 containing the selected link can be emphasized. The emphasized offer can be highlighted, colored, projected larger, outlined, displayed at the top of the list, or otherwise showcased by visible indicia.

The offer page can be pre-populated in accordance with the selected actionable link. For example, by selecting the reject offer link 315, a corresponding value in the offer page can be set to reject the offer. The publisher then need only to select, e.g., a submit button in the offer page to finalize the rejection. Alternatively, by selecting the accept offer link 310, the offer page can be pre-populated to accept the offer. Again, the publisher need only to select the submit button to finalize the acceptance. However, the publisher can change the pre-populated value in the offer page before selecting the submit button. Such an implementation can enable the publisher to consider the full presentation of details in the offer page before executing the response.

Alternatively, the actionable offer alert system can be implemented such that selecting one of the one or more actionable links included in the electronic message 305 can result in executing the selected response without presenting a corresponding offer page. For example, selecting the reject offer link 315 in the electronic message 305 can cause the actionable offer alert system to reject the offer without presenting the corresponding offer page. Thus, a publisher can reject an advertisement offer by selecting the reject offer link 315 without viewing the advertisement offer in the corresponding offer page. Additionally, the electronic message 305 can include a narrative 335 advising, encouraging, or otherwise directing an offer recipient to perform an action in response to an offer.

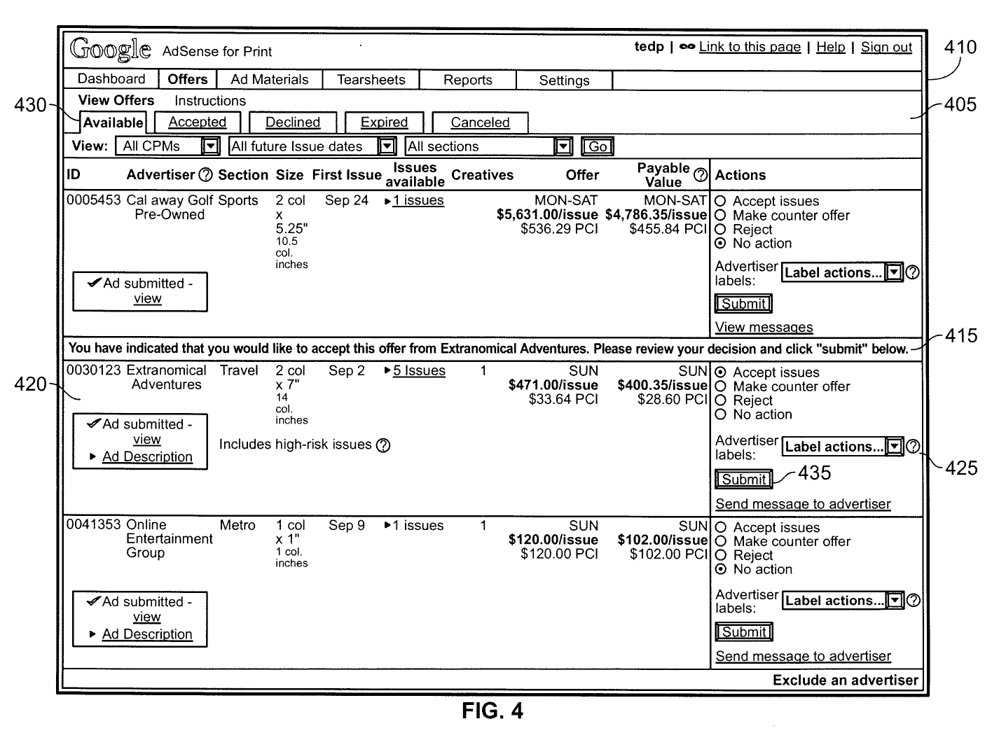

FIG. 4 shows an exemplary offer page 405 displayed in a web browser window 410. The offer page 405 can include a full description of the offer and one or more user prompts 415. The one or more user prompts 415 can direct an offer recipient to perform an action in response to the advertisement offer. For example, the user prompt 415 can indicate that acceptance of the offer can be confirmed by, e.g., selecting a submit button 435 associated with the offer. One of the one or more user prompts 415 can be associated with a current offer 420. The current offer 420 can be the offer identified in the electronic message from which an actionable link was selected to display the offer page 405, such as the electronic message 305. Alternatively, the one or more user prompts 415 can be associated with one or more previous offers.

The offer page 405 also can include one or more items of information corresponding to the current offer 420 to place an advertisement in the publication. The one or more items of information corresponding to the current offer can include: a publication identifier, an advertiser identifier, a section of the publication in which the advertisement will appear, a size of the advertisement, the first issue in which the advertisement will run, the number of issues for which the advertisement will run, the number of advertisements (or “creatives”), an offer value, a payable value, as well as other such information relating to the offer.

The offer page 405 also can include an action section 425. The action section 425 can include one or more actions to be taken in response to the advertisement offer, such as accepting, rejecting, making a counteroffer, or taking no action. The one or more actions associated with the offer can be represented as one or more radio buttons, which can be selected in response to the current offer 420. For example, the one or more radio buttons can include: an accept button, a reject button, a make counteroffer button, and a no action button. In some implementations, the action section 425 can include more, fewer, or different response buttons. Additionally, the one or more radio buttons included in the action section 425 can be associated with the one or more actionable links included in an electronic message, such as the electronic message 305. For example, the accept offer link 310 can correspond to an accept offer radio button in the action section 425. The one or more actions associated with the offer also can be represented in the action section 425 using one or more drop down menus with pre-populated values, data entry fields, checkboxes, sliders, or other such graphical user interface widgets.

Selecting an actionable link included in an electronic message, such as the electronic message 305, can result in the automatic population of a corresponding radio button in the offer page 405. For example, by selecting the submit counteroffer link 320 in the electronic message 305, the make counteroffer radio button of the action section 425 can be automatically selected when the offer page 405 is presented. Thus, one of the one or more radio buttons can be pre-populated as a result of one of the one or more actionable links in the electronic message 305 being selected. In a default implementation, or when the approve offers link 325 is selected, the no action radio button can be automatically selected when the offer page 405 is presented.

The association between selecting an actionable link and the pre-population of the corresponding radio button can make it possible to accept, reject, or counter an advertisement offer in a single action, such as by inputting a confirmation command, e.g., selecting the submit button 435, in the action section 425 of the offer page 405. Nonetheless, an alternative action can be selected in the offer page 405 by clicking on a different radio button in the action section 425 before the selection is submitted. For example, the accept offer link 310 can be selected in the electronic message 305 and presented as the pre-populated option in the offer page 405, but the reject offer radio button in the action section 425 can be selected before the action is submitted.

Further, the action section 425 can include a selectable label tool. The select label tool can be used to label, or “tag,” an advertisement offer. Labels can be used to organize advertisement offers by categories, e.g., food advertisement offers or travel advertisement offers, and to sort the pending advertisement offers by category in addition to sorting advertisement offers by other values, e.g., advertiser. The action section 425 also can include a message link for contacting the advertiser who submitted the corresponding offer.

Any number of pending offers associated with an entity, such as a publisher or publication, can be presented in the offer page 405. The offer page 405 also can include one or more tabs 430 to organize offers by status, such as available or pending offers, accepted offers, declined offers, expired offers, and cancelled offers. Additional details about the offer page can be found in U.S. Utility application Ser. No. 11/753,537 entitled “Electronic Advertising System” filed May 24, 2007, the entire contents of which are incorporated herein by reference.

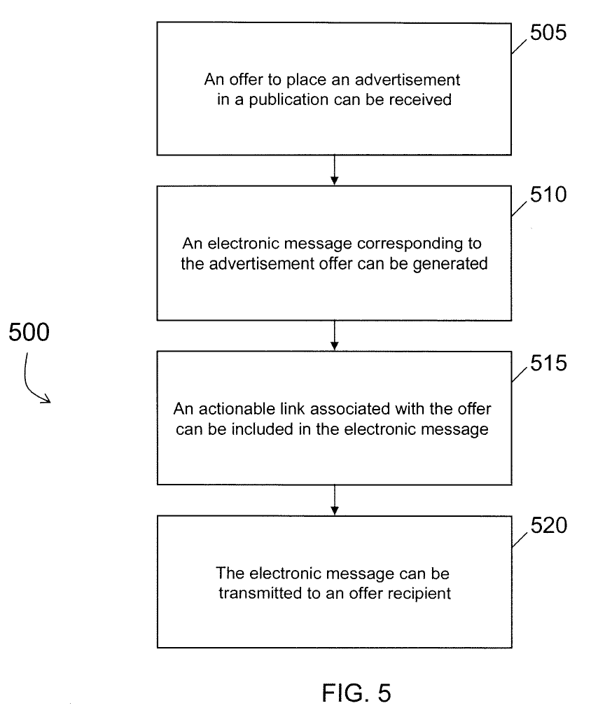

FIG. 5 is a flow diagram describing an exemplary data input process 500 for communicating an advertisement offer. The process 500 can, for example, be implemented to generate an electronic message, such as the electronic messages 105, 205, and 305 of FIGS. 1, 2, and 3, respectively.

An offer to place an advertisement in a publication can be received, e.g., by a publisher (505). The offer can be received electronically by an actionable offer alert system, which can include an actionable offer alert software application installed, e.g., on a computer system. Further, the advertisement offer can include one or more items of information, such as: the identity of the advertiser, the proposed publication dates, the section of the publication in which the advertisement is to be presented, the size of the advertisement, and the content of the advertisement. In some implementations, other information relating to the advertisement also can be included in the offer. The publication can be a print media publication, e.g., newspaper or magazine. Alternatively, the publication can be an electronic publication, e.g., electronic magazine (or “ezine”) or web log (or “blog”).

An electronic message corresponding to the advertisement offer can be generated (510). For example, the actionable offer alert system can generate an electronic message, e.g. an email, that includes one or more items of information corresponding to the offer. The one or more items of information can include: the publication to which the offer is directed, the section of the publication in which the advertisement is to appear, the identity of the advertiser, the advertisement size, the offer value, the payable value, the issue date, the number of issues in which the advertisement is to appear; and the advertisement description. In some implementations, other information relating to the offer also can be included. The electronic message also can include an offer summary and a narrative directing the offer recipient to take an action in response to the advertisement offer.

An actionable link associated with the offer can be included in the electronic message (515). The actionable link can be selected to respond to the offer. For example, the actionable offer alert system can insert one or more actionable links into the electronic message. Selecting, e.g., clicking on, an actionable link can cause an offer page to be presented, such as in a web browser. In some implementations, an actionable link included in the electronic message can be implemented as a hyperlink. The electronic message also can be implemented to include one or more actionable links associated with the offer, including: an accept offer link, a reject offer link, a counteroffer link, and a view offer link. Further, the actionable offer alert system can be configured such that selecting one of the one or more actionable links associated with the offer can cause one or more associated items included in the offer page to be pre-populated. For example, selecting an accept offer link included in the electronic message can cause an accept offer radio button to be automatically populated when the offer page is displayed. Similarly, selecting a reject offer link included in the electronic message can cause a reject offer radio button to be automatically populated when the offer page is displayed. In addition, selecting the view offer link included in the electronic message can cause the no action button to be automatically populated when the offer page is displayed.

The electronic message can be transmitted to an offer recipient (520). For example, the electronic message can be transmitted over an electronic communication network. The electronic communication network can be a public network, such as the internet, a private network, such as an intranet, or any combination of public and private networks. The actionable offer alert system can transmit the electronic message to one or more offer recipients, such as a publisher of the publication in which the advertisement is to appear. Further, the transmitted electronic message can be configured such that each actionable link in the electronic message is enabled when the electronic message is presented.

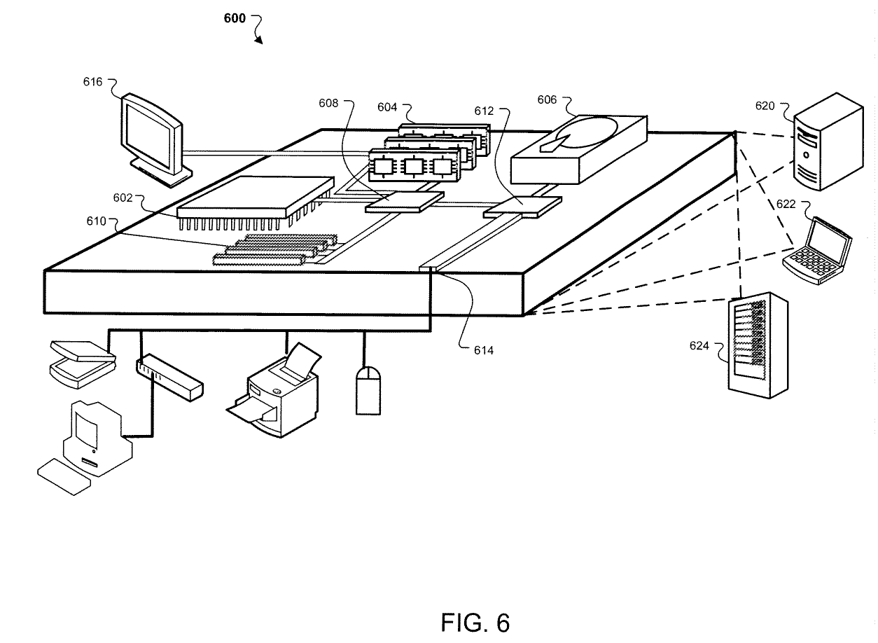

FIG. 6 is a schematic diagram of a computing device and system that can be used, e.g., to implement sending actionable offer alerts in electronic messages. Computing device 600 is intended to represent various forms of digital computers, such as laptops, desktops, workstations, personal digital assistants, servers, mainframes, and other appropriate computers. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connected to memory 604 and high-speed expansion ports 610, and a low speed interface 612 connected to low speed bus 614 and storage device 606. Each of the components 602, 604, 606, 608, 610, and 612, are interconnected using various buses, and can be mounted on a common motherboard or in other manners as appropriate. The processor 602 can process instructions for execution within the computing device 600, including instructions stored in the memory 604 or on the storage device 606, to display graphical information for a GUI on an external input/output device, such as display 616 coupled to high speed interface 608. Multiple processors and/or multiple buses can be used, as appropriate, along with multiple memories and types of memory. Also, multiple computing devices 600 can be connected, with each device providing portions of the necessary operations, e.g., as a server bank, a group of blade servers, or a multi-processor system.

The memory 604 stores data within the computing device 600. The memory 604 can be a volatile memory, non-volatile memory, or a combination thereof.

The storage device 606 is capable of providing mass storage for the computing device 600. The storage device 606 can be a floppy disk device, a hard disk device, an optical disk device, a tape device, a flash drive or other similar solid state memory device, or an array of devices, including devices in a storage area network or other configurations. A computer program product can be tangibly embodied in an information carrier. The computer program product can contain instructions that, when executed, perform one or more methods, such as those described above. The information carrier can be a computer- or machine-readable medium, such as the memory 604, or the storage device 606, memory on processor 602.

The high speed controller 608 can manage bandwidth-intensive operations for the computing device 600, while the low speed controller 612 can manage lower bandwidth-intensive operations. Such allocation of duties is exemplary only. The high-speed controller 608 can be coupled to memory 604, display 616 (e.g., through a graphics processor or accelerator), and to high-speed expansion ports 610, which can accept various expansion cards (not shown). The low-speed controller 612 can be coupled to storage device 606 and low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a computer 620. It also can be implemented as part of a rack server system 624. In addition, it can be implemented as a mobile computer 622, such as a laptop.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The subject matter described herein can be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein does not require the particular order shown, or sequential order, to achieve desirable results. Other embodiments may be within the scope of the following claims.

A number of implementations have been disclosed herein. Nevertheless, it will be understood that various modifications can be made without departing from the spirit and scope of the claims. For example, the actions recited in the claims can be performed in a different order and still achieve desirable results. Accordingly, other implementations are within the scope of the following claims.

For example, the techniques can be implemented to perform an action selected in an actionable link without requiring further confirmation. The techniques also can be implemented to perform an action by replying to an electronic message. In such an implementation, the action can be performed without presenting a corresponding offer page. The techniques also can be implemented to send an electronic message to the publisher confirming that the action has been performed.

What is claimed is:

1. A computer-implemented method of communicating an advertisement offer, the method comprising:
receiving an offer to place an advertisement in a publication;
generating an electronic message including one or more items of information corresponding to the offer;
including in the electronic message an actionable link associated with the offer, wherein the actionable link can be selected to respond to the offer; and
transmitting the electronic message to an offer recipient.

2. The method of claim 1, further comprising:
displaying an offer page including one or more fields corresponding to the offer in response to a selection of the actionable link.

3. The method of claim 1, wherein including in the electronic message an actionable link further comprises including in the electronic message a plurality of actionable links associated with the offer.

4. The method of claim 3, further comprising:
detecting a selection of one of the plurality of actionable links; and
responding to the offer based on the detected selection.

5. The method of claim 3, wherein in response to a selection of one of the plurality of actionable links, at least one field included in the offer page is pre-populated in accordance with the actionable link selected.

6. The method of claim 3, wherein the plurality of actionable links include one or more of an accept link, a reject link, a counteroffer link, and a view offer link.

7. The method of claim 1, wherein the one or more items of information corresponding to the offer includes at least one of:
a publication identifier, an advertiser identifier, an offer value, an issue date, and an advertisement description.

8. The method of claim 1, wherein the actionable link associated with the offer comprises a hyperlink.

9. A computer program product, encoded on a computer-readable medium, operable to cause data processing apparatus to perform operations comprising:
accepting an offer to place an advertisement in a publication;
generating an electronic message including one or more items of information corresponding to the offer;
including in the electronic message an actionable link associated with the offer, wherein the actionable link can be selected to respond to the offer; and
conveying the electronic message to an offer recipient.

10. The computer program product of claim 9, further operable to cause data processing apparatus to perform operations comprising displaying an offer page including one or more fields corresponding to the offer in response to a selection of the actionable link.

11. The computer program product of claim 9, wherein including in the electronic message an actionable link further comprises including in the electronic message a plurality of actionable links associated with the offer.

12. The computer program product of claim 11, further operable to cause data processing apparatus to perform operations comprising:
detecting a selection of one of the plurality of actionable links; and
responding to the offer based on the detected selection.

13. The computer program product of claim 11, wherein in response to a selection of one of the plurality of actionable links, at least one field included in the offer page is pre-populated in accordance with the actionable link selected.

14. The computer program product of claim 11, wherein the plurality of actionable links include one or more of an accept link, a reject link, a counteroffer link, and a view offer link.

15. The computer program product of claim 9, wherein the one or more items of information corresponding to the offer includes at least one of:
a publication identifier, an advertiser identifier, an offer value, an issue date, and an advertisement description.

16. The computer program product of claim 9, wherein the actionable link associated with the offer comprises a hyperlink.

17. A system comprising:
a processor; and
a computer readable medium storing a computer program for communicating an advertisement offer, the computer program comprising instructions to cause the processor to perform operations comprising:
receiving an offer to place an advertisement in a publication;
generating an electronic message including one or more items of information corresponding to the offer;
including in the electronic message an actionable link associated with the offer, wherein the actionable link can be selected to respond to the offer; and
transmitting the electronic message to an offer recipient.

18. The system of claim 17, the operations further comprising displaying an offer page including one or more fields corresponding to the offer in response to a selection of the actionable link.

19. The system of claim 17, wherein including in the electronic message an actionable link further comprises including in the electronic message a plurality of actionable links associated with the offer.

20. The system of claim 19, the operations further comprising:
detecting a selection of one of the plurality of actionable links; and
responding to the offer based on the detected selection.

21. The system of claim 19, wherein in response to a selection of one of the plurality of actionable links, at least one field included in the offer page is pre-populated in accordance with the actionable link selected.

22. The system of claim 19, wherein the plurality of actionable links include one or more of an accept link, a reject link, a counteroffer link, and a view offer link.

23. The system of claim 17, wherein the one or more items of information corresponding to the offer includes at least one of:
a publication identifier, an advertiser identifier, an offer value, an issue date, and an advertisement description.

24. The system of claim 17, wherein the actionable link associated with the offer comprises a hyperlink.
